(19) United States
(12) Patent Application Publication
(10) Pub. No.: US 2025/0327435 A1
(43) Pub. Date: Oct. 23, 2025

(54) Apparatus and Method Utilizing Energy Recovery Devices, Including in Fluid Separation Processes

(71) Applicant: AMORPHIC TECH LTD., Allentown, PA (US)

(72) Inventor: Andrew SCHEVETS, Emmaus, PA (US)

(21) Appl. No.: 19/175,571

(22) Filed: Apr. 10, 2025

Related U.S. Application Data
(60) Provisional application No. 63/632,263, filed on Apr. 10, 2024.

(51) Int. Cl. F03B 17/00; C02F 1/44

(52) U.S. Cl. CPC F03B 17/00; C02F 1/441; C02F 2201/002; F05B 2220/32

(57) ABSTRACT

A novel approach for applying energy recovery devices (“ERD”s) to fluid systems which increases the fluid pressure by using ‘waste’ stream energy, and concurrently obviate the need an ancillary power source such as a motor or engine directly connected to the energy recovery device. This is achieved using a system or apparatus comprising two or more energy recovery devices, and/or at least one (or two or more) energy recovery device having two or more energy recovery device stages, wherein the system or apparatus has a pumping (or compressing) circuit of the energy recovery devices are arranged in parallel, while the turbine (or motor) circuit of the energy recovery devices are arranged in series. An advantage of such systems or apparatus provides that the one or more energy recovery devices now operate as an intensifier, increasing the pressure available to a given process, i.e., a separation process. A further advantage of such systems or apparatus is in the provision of a significant disparity in the flowrates of a process.

The present application claims priority to U.S. patent application Ser. No. 63/632,263 filed 10 Apr. 2024, the entire disclosure of which is herein incorporated by reference.

The present invention was made with government support under DE-SC0020193 awarded by the U.S. Department of Energy.

Energy recovery devices (“ERD”s) are used in various technical fields and technical processes. One such technical field/process of interest is in reverse osmosis water purification systems. The types of ERDs applied can be divided into two primary categories—isobaric (piston type or pressure exchanger type) or rotational (centrifugal turbo-pump or pelton turbines). Such are described in “Comparison of two types of energy recovery devices: pressure exchanger and turbine in an island desalination project case”, C. Wang, Desalination, Vol. 533, 1 Jul. 2022. Isobaric energy recovery devices are typically applied in parallel with the high pressure pump and require a booster pump to maintain positive pressure and flow. In this case, the ERD only handles a portion of the overall flow, as it is in parallel with the high pressure pump. Conversely, centrifugal turbopumps are typically applied as boosters, employed in series with the high pressure pump and receiving the full process flow. However, where the process is a reverse osmosis water purification system, the flowrate of the brine (or reject stream) is significantly less than the overall feed flow to the membranes. The ratio of permeate flow to feed flow is called the recovery rate. Typical recovery rates for membrane based purification processes are 40 to 75%, however sometimes can vary as much as 10% to 90%. Disparity in the flowrate of the streams (comparing pump circuit to turbine circuit) results in a turbo-pump requiring impellers of significantly different specific speeds (Ns). Specific speed is the relationship between an impellers rotational speed, flow rate, and pressure. Significantly different specific speeds for the pump impeller vs turbine impeller result in an overall less efficient hydraulic efficiency.

Hence a real and urgent need exists in providing improvements in systems comprising ERDs used in various technical fields and technical processes, and in particular in reverse osmosis water purification applications and systems.

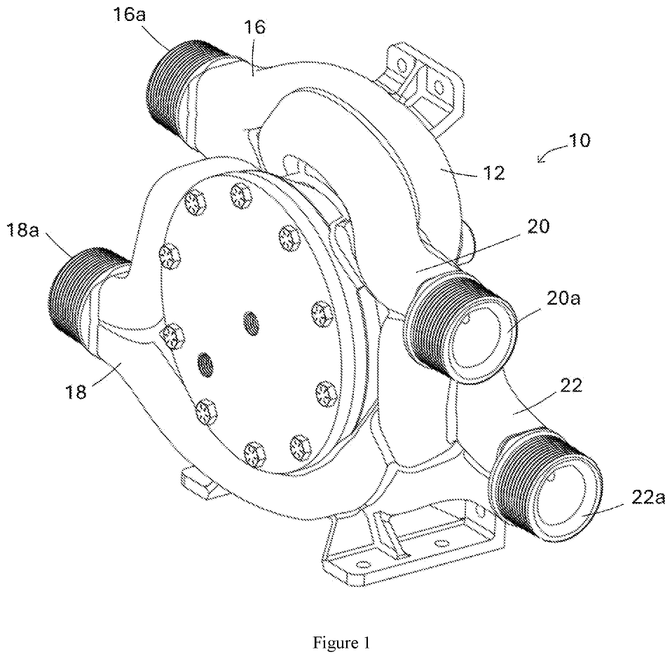

FIG. 1 depicts in a perspective view, charging fluid, feed fluid, inlets, outlets, lobes, the rotor and vanes within a rotor chamber.

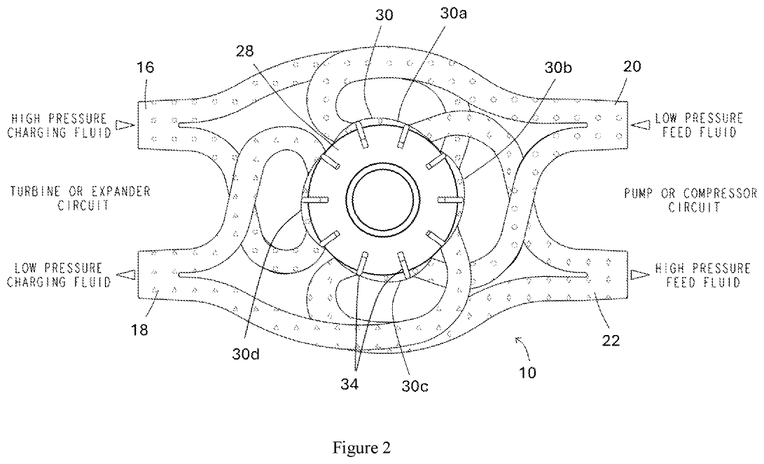

FIG. 2 depicts in a representational view, charging fluid, feed fluid, inlets, outlets, lobes, the rotor and vanes within a rotor chamber.

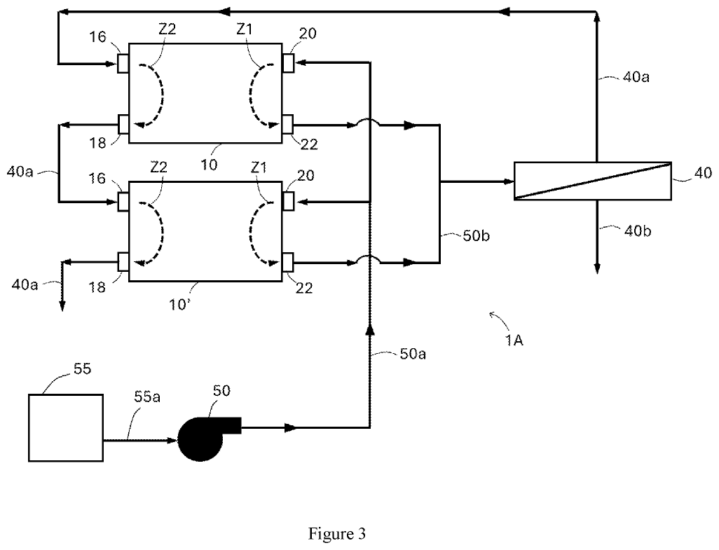

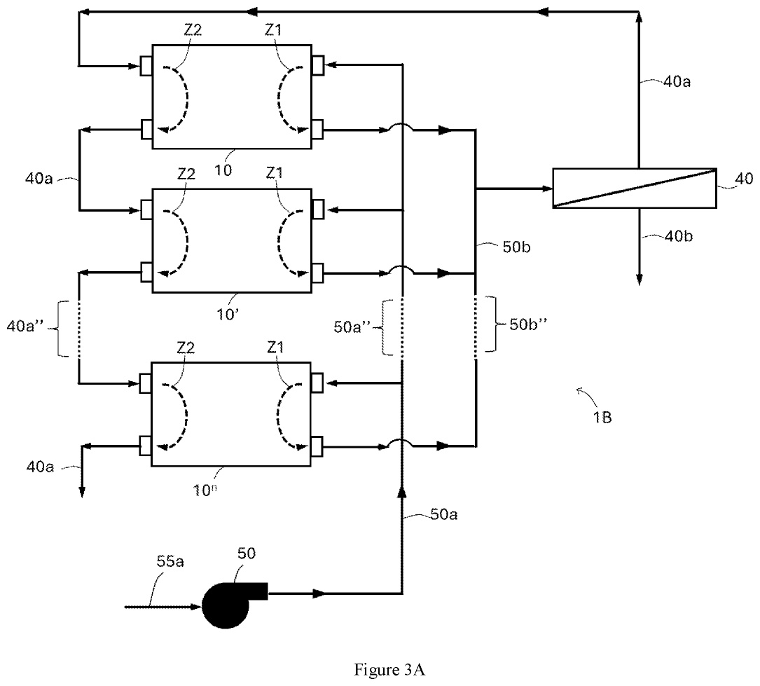

FIG. 3 depicts a first embodiment of a system comprises two or more energy recovery devices used in an example of a separation process.

FIG. 3A depicts a variant of an embodiment of FIG. 3, comprising at least one or more additional ERDs.

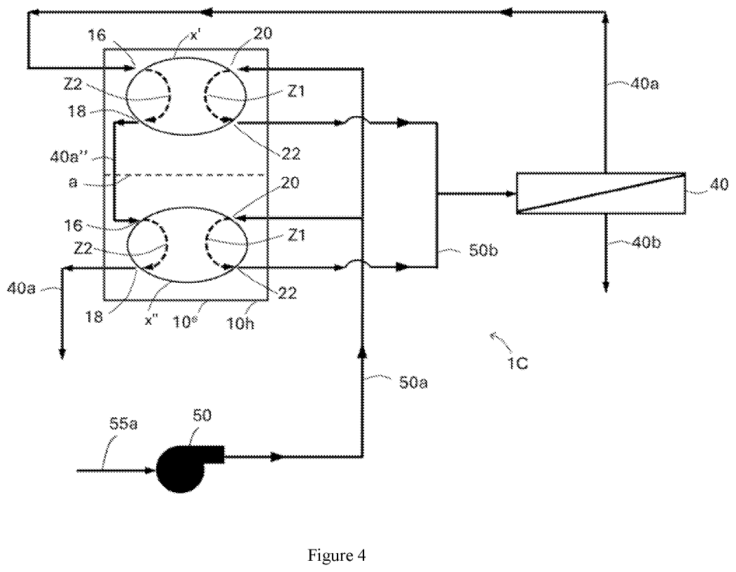

FIG. 4 depicts further embodiment of an apparatus and system for a separation process according to the invention, comprising of a ‘combined’ or ‘unitary’ energy recovery device comprising a plurality of energy recovery device stages.

Various ERDs are known to the art, and may be used in all aspects him and embodiments of the present invention. A preferred example of an energy recovery device (“ERD”) which finds use in conjunction with the present invention is a unitary pump and turbine energy exchanger, such as is disclosed in U.S. Pat. No. 9,759,066 (Amorphic Tech Ltd.). By this reference thereto, the entire disclosure of U.S. Pat. No. 9,759,066 is herein incorporated by reference. The energy recovery device disclosed therein is a positive displacement unitary pump and turbine operable as a fluid energy exchanger which used and acts upon a separate feed that exits the turbine at an elevated energy state. The said device includes a rotor casing which defines a rotor chamber and each lobe has an inlet port and an outlet port defined by the contoured wall, and the rotor has a plurality of vanes that follow the contoured wall as the rotor turns, usually in a clockwise direction. In operation, the rotor is driven by the charging fluid entering first and second lobes, located generally opposite one another, and exiting the lobes at a lower energy state. The driven rotor operates to elevate the energy level of a feed fluid in third and fourth lobes, located also generally opposite one another, which feed fluid enters at a lower energy state, and the feed fluid exits at a higher energy state. In this configuration, a unitary pump and turbine energy exchanger excludes any electrical motor or other drive means for causing the rotation of the rotor. A preferred embodiment of this positive displacement unitary pump and turbine is illustrated in FIG. 1 in a perspective view, and in FIG. 2 in a representational view which depicts the charging fluid, feed fluid, inlets, outlets, lobes, the rotor and vanes within the rotor chamber. While effective, a shortcoming of such ERDs as disclosed in in U.S. Pat. No. 9,759,066 is that these devices typically require an essentially equal volumetric flow rate of both fluids passing through the device during operation, as an imbalance or deficiency in one fluid flows (mass, and/or volume of fluid) leads to an imbalance and may lead to a phenomenon referred to as ‘rotor lock up’ wherein the rotor is immobilized and thus the ERD ceases to function.

Hereinafter, in the various drawing figures, reference numerals and labels are used to refer to the same or similar elements.

With reference now to FIG. 1, depicted is a form of an ERD (as disclosed in in U.S. Pat. No. 9,759,066), embodied as a unitary pump and turbine energy exchanger 10 having a pump or turbine body 12, having four fluid conduits 16, 18, 20, 22 respectively having ports 16a, 18a, 20a, 22a through which a fluid (liquid, or gas) enters or exits the unitary pump and turbine energy exchanger 10 during its operation. Internal to the pump or turbine body 12 is a rotor chamber 30 having at least four lobes, respectively 30a, 30b, 30c, 30d each spaced apart from each other with a first pair of lobes 30a, 30c opposite from each other across the rotor chamber 30, and the second pair of lobes 30b, 30d opposite from each other across the rotor chamber 30. Fluid conduit 16 is in fluid communication with an upstream part of lobes 30b and 30d, and fluid conduit 18 is in fluid communication with a downstream part of lobes 30b and 30d. Fluid conduit 20 is in fluid communication with an upstream part of lobes 30a and 30c, and fluid conduit 22 is in fluid communication with a downstream part of lobes 30a and 30c. In operation as the rotor 28 rotates (usually clockwise), fluid traverses from the upstream to the downstream lobes of the respective, as is understood from FIG. 2, entry of a higher pressure charging fluid into fluid conduit 16 enters lobes 30b and 30d, impinges on one or more of the moveable vanes 34 extending outwardly from the rotor 28 but within the rotor chamber 30, and exits in the downstream part of the lobes 30b, 30d and exits via fluid conduit 18. Typically a pressure drop across fluid conduits 18 and 16 occurs, and energy is transferred within the unitary pump and turbine energy exchanger 10 to the feed fluid which is present within the rotor chamber 30. The feed fluid enters fluid conduit 20, and enters the upstream part of lobes 30a and 30c, impinges on one or more of the moveable vanes 34 extending outwardly from the rotor 28 but within the rotor chamber 30, and exits in the downstream part of the lobes 30a and 30c, and exits via fluid conduit 22. The transferred energy within the rotor chamber 30 typically increases the energy level (thermal a/o kinetic a/o pressure) between the fluid conduit 20 and fluid conduit 22, and usually the outlet pressure at or in the fluid conduit 22 is increased with respect to the inlet pressure at or in the fluid conduit 20. This transfer of energy occurs without the need for any motor or other force imparting mechanical or electromechanical device, i.e, a motor or engine.

While the ERD is preferably a unitary pump and turbine energy exchanger as described herein, particularly with reference to FIGS. 1 and 2, it is to be clearly understood that different configurations of ERDs, namely centrifugal turbo-pumps, as well as apparatus which may include in their constructions centrifugal pumps may be used in place of, or in conjunction with the a unitary pump and turbine energy exchangers in forming in systems comprising ERDs used in various technical fields and technical processes according to the invention, and in particular in reverse osmosis water purification applications and systems as described in more detail hereinafter. Utilizing centrifugal turbo-pump type ERDs, provides an additional benefit from the present invention—the turbine impeller and pump impeller are now able to have more closely aligned to specific speeds, which allows for higher efficiency operation and such a broader range of efficient operation of the device is advantageous to overall efficiency as the pump efficiency curves are better aligned.

In one aspect the present invention relates to system or apparatus comprising two or more energy recovery devices, and/or at least one (or two or more) energy recovery device having two or more energy recovery device stages, wherein the system or apparatus has a pumping (or compressing) circuit of the energy recovery devices are arranged in parallel, while the rotor or turbine circuit of the energy recovery devices are arranged in series. An advantage of such systems or apparatus provides that the one or more energy recovery devices now operate as an intensifier, increasing the pressure available to a given process, i.e., a separation process. Thus, at least one of the fluid streams exiting the energy recovery devices may be utilized to drive a further apparatus within the system, thereby obviating the need for external or supplemental energy sources. A further advantage of such systems or apparatus is in the provision of a significant disparity in the flowrates of a process between the two sides of ERDs, yet without compromising their operation.

Successful application of the present invention has additional benefit of allowing a lower pressure pump feeding the system then might otherwise be required. Reducing the pressure requirements of this pump decreases its capital cost (thinner wall thicknesses and lower duty mechanical seal), increases its efficiency (the pump is now able to have impeller geometry in a more efficient specific speed regime), and also an overall increase in the efficiency of the systems as less power consumption from needing to add less pressure.

Broadly speaking the systems and apparatus of the invention are applicable in fluid processes and fluid circuits wherein a plurality of ERDs are utilized (particularly preferably such as is disclosed in U.S. Pat. No. 9,759,066) as the inventor has surprisingly found that having an arrangement of at least two ERDs, each having at least two separate internal fluid circuits passing therethrough via a rotor, turbine or impeller, whereby a first fluid in a first internal fluid circuit (z1) has this energy intensified (i.e., pressure), while concurrently a second fluid in a second internal fluid circuit (z2) has its energy (i.e., pressure) decreased, can be reliably operated even where the operational characteristics, that is to say the size, capacity, or other differentiating parameter of at least a first ERD and at least a second ERD may be different, (but may also be the same) when arranged, such that all the first internal fluid circuits are interconnected as in parallel circuits, with each ERD's input individually connected to an inlet manifold and each ERD's output is individually connected to a separate outlet manifold, while at the same time all of the second internal fluid circuits of the plurality of ERDs are connected in series, such that an inlet of the second internal fluid circuit of an ERD is connected to the outlet of the second internal fluid circuit of a prior (or upstream) ERD. Thus, system or apparatus of the invention may comprises ERDs of the same configuration or of two or more different configurations.

The arrangement of the several ERDs, each having an inlet to their first internal fluid circuit (z1) connected and in fluid communication with a first common conduit, pipe, tube or manifold, and each having an outlet of their first internal circuit (z1) connected to and in fluid communication with a second separate common conduit, pipe, tube or manifold, provides a system wherein fluid in the first common conduit, pipe, tube or manifold at a first pressure, the volume of the fluid being distributed amongst the several ERD, viz in a ‘parallel’ manner which usually provides for similar amount of the fluid being separately processed by each of the ERDs, within which the pressure is increased such that the fluid exiting each ERD via their outlet and to said second separate common conduit, pipe, tube or manifold at a second and higher pressure than the said first ‘common’ inlet pressure. Thus, the volumetric distribution of the fluid may take place, wherein the total mass of fluid is split amongst the several ERDs. In the case of the use of ERDs of similar or same operational characteristics or capacities, an approximately equal distribution of the fluid takes place. In the case where ERDs of different operational characteristics or capacities, a non-equal distribution may take place. Nonetheless as all outputs of the first internal circuits (z1) are combined in the second separate common conduit, pipe, tube or manifold, (and thereafter directed to a downstream separator unit) systems and apparatus of the invention are not limited to only one type of ERDs. Also, with the addition of further additional ERDs in greater number a greater volumetric capacity of fluid may be processed with within the system and apparatus, while not compromising the individual performance of individual ERDs.

In distinction to the above parallel interconnection of the first internal circuits (z1) of the ERDs, (which may sometimes also be called a ‘pump side’), the second internal circuits (z2) (which may sometimes also be called the ‘turbine side’) of the ERDs as at least two, preferably all of its ERDs connected in a ‘series’ manner wherein the output of the is in fluid communication with the input of the second circuit (z2) of a next ERD, which pattern continues between the input of a first ERD to the output of the last of a series of ERDs, which may be in fluid connection to an outlet conduit, pipe, or tube. In this manner a single ‘serial’ fluid path may be formed.

In such an arrangement, particularly under steady state operation, the inventor provides a system and apparatus wherein two or more ERDs which when arranged in said manner will still reliably operate even wherein, within each of the ERDs, the pressure of fluids within the first internal fluid circuit and the second internal fluid circuit within each of the plurality of ERDs may be different, even to a significant extent but reliable operation of the system and apparatus may be maintained.

At the same time, in such an arrangement, and under steady state operation the inventor provides a system and apparatus of two or more ERDs which when arranged in said manner reliably operate, even wherein there exists a pressure differential between the first common conduit, pipe, tube or manifold, and/or the second common conduit, pipe, tube or manifold and the outlet conduit, pipe, or tube.

In one aspect the present invention provides a system or apparatus comprising two or more energy recovery devices, and/or at least one (or two or more) energy recovery device having two or more energy recovery device stages, wherein:
each of energy recovery devices having a first internal fluid circuit having an inlet and an outlet, a second internal fluid circuit having an inlet and an outlet, a rotor or turbine which, operates in response to differential pressures between the inlet and outlet of the first internal circuit, and/or operates in response to differential pressures between the inlet and outlet of the second internal fluid circuit, such that during operation a pressure increase in a fluid in the first internal fluid circuit occurs while a pressure decrease in a fluid in the second internal fluid circuit occurs due to energy transfer between the first internal fluid circuit and the second internal fluid circuit;
the inlets of each of the first internal fluid circuits connected and in fluid communication with a first common conduit, pipe, tube or manifold, and
the outlets of each of the first internal fluid circuits connected to and in fluid communication with a second separate common conduit, pipe, tube or manifold, thereby forming a parallel circuit of the first internal fluid circuits of the energy recovery devices;
the outlet of the second internal fluid circuit of an upstream energy recovery device in fluid communication to the inlet of the second internal fluid circuit of downstream energy recovery device, and thereby forming a series circuit between said energy recovery devices;
a pump, in fluid communication with the first common conduit, pipe, tube or manifold via which is supplied a pressurized fluid to the energy recovery devices,
a separator unit, having an input fluid communication with the second separate common conduit, pipe, tube or manifold, further having at least two outlets, one of the outlets being in fluid communication with the series circuit between second internal fluid circuits of the energy recovery devices.

Also the invention provides in such an arrangement, and under steady state operation, a system and apparatus of two or more ERDs which when arranged in said manner reliably operate, even wherein there exists a pressure differential between the first common conduit, pipe, tube or manifold, and/or the second common conduit, pipe, tube or manifold and the outlet conduit, pipe, or tube, and the outlet of one or more second circuit (z2) of one or more of the ERDs present.

The difference in the pressure between the first internal fluid circuit and the second internal fluid circuit may vary to greater or lesser extents, such as from about 0.5% to about 85%, preferably between about 0.5% to about 75%, still more preferably between about 0.5% and 50%, and in order of increasing preferably between about; 0.5% to 45%, 0.5% to 40%, 0.5% to 35%, 0.5% to 30%, 0.5% to 25%, 0.5% to 20%, 0.5% to 15%, 0.5% to 10%, and 0.5% to 5%. Another set of preferred ranges of such differences in the pressure within an ERD between the first internal fluid circuit and the second internal fluid circuit may vary to greater or lesser extent, such as from about 1% to about 85%, preferably between about 1% to about 75%, still more preferably between about 1% and 50%, and in order of increasing preferably between about; 1% to 45%, 1% to 40%, 1% to 35%, 1% to 30%, 1% to 25%, 1% to 20%, 1% to 15%, 1% to 10%, and 1% to 5%. Yet another preferred ranges of such differences in the pressure between the first internal fluid circuit and the second internal fluid circuit within an ERD may vary to greater or lesser extends, such as from about 1.5% to about 85%, preferably between about 1.5% to about 75%, still more preferably between about 1.5% and 50%, and in order of increasing preferably between about; 1.5% to 45%, 1.5% to 40%, 1.5% to 35%, 1.5% to 30%, 1.5% to 25%, 1.5% to 20%, 1.5% to 15%, 1.5% to 10%, and 1.5% to 5%. Still further preferred ranges of such differences in the pressure between the first internal fluid circuit and the second internal fluid circuit may vary to greater or lesser extents, such as from about 2% to about 85%, preferably between about 2% to about 75%, still more preferably between about 2% and 50%, and in order of increasing preferably between about; 2% to 45%, 2% to 40%, 2% to 35%, 2% to 30%, 2% to 25%, 2% to 20%, 2% to 15%, 2% to 10%, and 2% to 5%.

Even with differences in the pressures within the first internal fluid circuit and the second internal fluid circuit present in each ERD, reliable operation of the overall fluid processes and fluid circuits of the system and apparatus, wherein a plurality of ERDs are utilized is provided. Ideally also, the phenomenon referred to as ‘rotor lock up’ wherein the rotor is immobilized and thus one or more of the ERDs cease to function, is overcome notwithstanding the disparity in the fluid pressures between the first internal fluid circuit and the second internal fluid circuits.

Additionally even with differences in pressures of the fluids present between differential between (A) the first common conduit, pipe, tube or manifold, and/or the second common conduit, pipe, tube or manifold, and (B) the outlet conduit, pipe, or tube and/or the outlet of one or more second circuit (z2) of one or more of the ERDs present. the phenomenon referred to as ‘rotor lock up’ wherein the rotor is immobilized and thus an ERD ceases to function, is overcome notwithstanding the disparity in the fluid pressures between (A) and (B). The difference in the pressure between the (A) and (B) may vary to greater or lesser extents, such as from about 0.5% to about 85%, preferably between about 0.5% to about 75%, still more preferably between about 0.5% and 50%, and in order of increasing preferably between about; 0.5% to 45%, 0.5% to 40%, 0.5% to 35%, 0.5% to 30%, 0.5% to 25%, 0.5% to 20%, 0.5% to 15%, 0.5% to 10%, and 0.5% to 5%.

At the same time, during steady state operation of the system and process, a (so called) waste stream may be caused to flow through the second internal fluid circuits (z2) viz, the turbine side, of the several ERDs, operating the several ERDs to effectively boost the pressure (or other energy, i.e., temperature) of material (i.e, fluid) within the first internal fluid circuits (z1), viz., the pump side, of the several ERDs thus boosting the pressure (or other energy) of the material exiting each of said first internal fluid circuits above the material's inlet pressure (or other energy), which exiting material may be passed downstream to a further unit or process, such as a separation unit which may divide the exiting material into separate streams. In a preferred embodiment at least one of these separate streams is the waste stream which is pressurized (or otherwise energized) which is provided to the second internal fluid circuits (z2) of at least two serially interconnected ERDs and used to operate the several ERDs. In this manner, the overall operating efficiency of the system and process has the benefit of improved overall operational efficiency and reduced energy consumption which might otherwise be necessary to operate the system and apparatus. In certain embodiments, and with respect to the plurality of ERDs present, whether considered individually or collectively, energy is transferred from the second internal fluid circuit (z2) to the first internal fluid circuit (z1) which increases the energy level of material (i.e. liquid, gas, other) transiting through the first internal fluid circuit (z1). In certain preferred embodiments, due to this energy transfer from material in the second fluid circuit (z2) to material in the first fluid circuit (z1), an energy increase, preferably a pressure increase of at least about 1%, more preferably (and in order of increasing preference) of at least 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61% 62%, 63%, 64%, 65%, 66%, 67%, 60%, 69%, 70%, 71%, 72%, 73%, 74% 75%, 76%, 77%, 78%, 79%, 80%, and even higher such as 85%, 90%, etc. is provided.

Such operation is particularly beneficial wherein the flowrates present in a system or apparatus also includes a separation unit, which may operate above atmospheric pressure and which separates part of the mass of materials entering from one (or more) input ports or streams, into at least two (or more) output ports or streams, and where the outputs of the first internal fluid circuits of the two or more ERDs are supplied as an input to the separation unit as a fluid, and wherein at least one of the outputs of the separation unit provides the input to the serially interconnected second internal fluid circuits of the two or more ERDs. In such an arrangement, notwithstanding a sequential decrease in pressure in the serially interconnected second internal fluid circuits (z2) of the series of ERDs, surprisingly the inventor's arrangement of the overall fluid processes and fluid circuits of the system and process, the turbine side, viz, the second internal fluid circuits (z2) of the ERDs operate, although undergo a decrease in energy, between the first and the last serially connected ERDs. It was unexpectedly found that notwithstanding the differential in pressures within the first internal circuits and second internal circuits of the plurality of ERDs, each ERD operated reliably. Also it was surprisingly found that when ERDs were of similar operational characteristics, a relatively proportional decrease in pressure across all of the ERDs present occurred. That is to say, in preferred embodiments, that the pressure drop between the input port of the second internal fluid circuit of a first or most ‘upstream’ ERD, and the outlet port of the second internal fluid circuit of the last or most ‘downstream’ ERD, was approximately equally divided by the number of ERDs present. This surprising result facilitated not only the continued reliable operation of the several ERDs particularly under steady state operational conditions, but also allows for the provision of a system and apparatus wherein at least two of the ERDs present may be of different operational capacities or specifications or more simply put, may be differently sized or operating ERDs. Such differences include but are not limited to: rotor or turbine sizes, rotor or turbine volumetric capacities, rated duty loads, fluid throughput ratings as well as others. In such an embodiment, a proportional pressure drop is anticipated. Hence, the system and apparatus comprising at least two ERDs appears to have a self-balancing effect, notwithstanding differences in size, capacity, or other differentiating parameter of two or more of the ERDs present. Of course the present invention may be practiced with similar or identical individual ERD units, but the options for variations in the individual ERD units is possible.

With regard to separation units, while in the following examples and drawing figures are described using a membrane separation unit for treatment of an aqueous liquids, it is nonetheless to be appreciated that the invention equally applies to any and all liquids, gases, etc. although not explicitly described herein.

Furthermore any other type of separation unit as may be appropriate to a different process may be used.

A first embodiment of a system comprises two or more energy recovery devices used in an example of a separation process. Such is described on FIG. 3. Here the separation process is a reverse osmosis water purification system, but the principles of the present invention find applicability in other technical processes. By way of illustration and not by limitation, the embodiment of a system comprising two or more energy recovery devices may also be used in other applications including but not limited to: refrigeration, chemical processing, oil extraction, refining and other systems and other processes which may include a separation step.

Turning now to FIG. 3, therein is depicted in a schematic view an apparatus and system for a separation process, here comprising two ERDs 10, 10′ each having two fluid inlets 16, 20, and two fluid outlets 18, 22 and within their interior is shown (in an arc, using broken lines) the fluid paths between the high pressure fluid inlet 16 and low pressure fluid outlet 20, and the fluid path between the high pressure feed inlet 20, and the low pressure feed outlet 22. The fluid path “z1” exemplifies a first internal fluid circuit and the fluid path “z2’ exemplifies a second internal fluid circuit within each ERD 10, 10′. As the operation of each of the ERDs may be the same or different then that as has been described with reference to exemplary ERDs of FIGS. 1 and 2, the ERDs 10, 10′ are only depicted schematically as different ERDs may be used.

Further visible is a high pressure pump unit 50, a supply vessel 55, and a reverse osmosis unit 40; (viz., a separator unit) all of the foregoing are fluidly interconnected by suitable appropriate conduits, i.e., pipes, tubes and/or manifolds to establish an apparatus and system for a separation process 1A. Beginning with the supply vessel 55 containing a ‘feed’ liquid, a feed supply tube 55a provides a fluid connection to a (high-pressure) pump 50 which during operation, increases its internal pressure to provide a fluid stream of the feed liquid. In current embodiment, brackish water, or other aqueous liquid requiring treatment via the reverse osmosis unit 40 is pumped via feed inlet liquid manifold 50a, having two branches which respectively enter the high pressure fluid inlet 16 of each of the ERDs 10, 10′, in a parallel manner. The feed liquid is processed in the ‘pump side’ of each of the ERDs 10, 10′ and exits each via its individual low-pressure feed outlet 22 where it is joined and combined in feed outlet liquid manifold 50b and from whence it is supplied by a branch into the inlet of the reverse osmosis unit 40, in which it is processed. A separated pressurized ‘waste’ liquid stream exits via tube 40a, and ‘product’ liquid stream, (here a permeate product), which exits via tube 40b, from whence it can pass downstream to a further part of a process, or collected in a suitable vessel or container. The pressurized ‘waste’ liquid passes via tube 40a, first to the high pressure fluid inlet 16, and is processed within the ‘turbine side’ of the first, or upstream ERD 10, and then exits the low pressure fluid outlet 18, and in turn is passed via tube 40a, in a serial manner, to the high pressure fluid inlet 16 of the next, or downstream ERD 10′, wherein in a similar manner, the ‘waste’ liquid is processed within this second ERD 10′, after which it exits via the low pressure fluid outlet 18, from when it may be passed downstream, optionally to a further part of the process, or collected or disposed of in a responsible manner. In such a manner, the turbine sides of the ERDs are serially interconnected.

An important technical feature of the apparatus and system as discussed in this foregoing FIG. 3 is that the operation of the two the ERDs 10, 10′ are driven by the pressure of the ‘waste’ liquid within each of these units, which ‘waste’ liquid is a product of the reverse osmosis unit 40 from which energy may be further extracted in order to operate the two ERDs. In certain particularly preferred embodiments the ERDs are not powered by any other external power supply, motor, engine or the like which would require a further energy input to the ERDs of the apparatus and system in order to perform the process.

It is to be added, and understood that while in many preferred embodiments the ERDs are not powered by any other external power supply, motor, engine or the like which would require a further energy input to the apparatus and system in order to perform the process, yet effectively boost the energy of the fluid entering a separation unit, (i.e, the reverse osmosis unit 40 of the drawing figures) there may be instances that (a) one or more of the ERDs are supplied with a supplemental power source, or supply, motor, engine or the like to boost their operational characteristics, and/or (b) within the system an apparatus one or more further pumps or compressors, as appropriate to the application and process may be further included in addition to the pump 50 as shown. Also, pump 50 may be a different apparatus, i.e., a compressor, especially when a non-liquid fluid is used in a process.

A variant of the embodiment of the system and apparatus of FIG. 3 is disclosed on FIG. 3A which includes many of the same elements, with the primary difference being in that at least one or more additional ERDs, here represented by the additional ERD 10ⁿ may be included in the apparatus and system for a separation process, referred to as 1B. As is understood, to accommodate at least one additional ERD, the lengths or configuration of the feed inlet liquid manifold 50a, the feed outlet liquid manifold 50b, and the tube 40a may require modification and such modification regions are correspondingly identified as 50a″ of the feed inlet liquid manifold, as 50b″ for the feed outlet liquid manifold, and 40a″ for the tube.

An important technical feature of the apparatus and system as discussed in this foregoing FIG. 3A is that the operation of the at least three ERDs 10, 10′ and 10ⁿ are driven by the pressure of the ‘waste’ liquid within each of these units, which ‘waste’ liquid is a product of the reverse osmosis unit 40 from which energy may be further extracted in order to operate the three or more ERDs, which desirably are also not powered by any other external power supply, motor, engine or the like which would require a further energy input to the apparatus and system in order to perform the process. A further technical advantage is the ability to adjust the amount of units in parallel series to accommodate different system recovery rates of a product of the separation unit.

A further embodiment of an apparatus and system for a separation process, having many similar elements as discussed with reference to prior FIGS. 3 and 3A is schematically depicted on FIG. 4, and generally referred to as C1. The system and process 1C illustrates an embodiment very similar in respects to FIG. 3, but here the primary different is the provision of a ‘combined’ or ‘unitary’ energy recovery device comprising a plurality of energy recovery device stages; here two energy recovery device stages x′, x″ are illustrated in FIG. 4. However, it is readily contemplated that three or more energy recovery device stages may be included in such a combined energy recovery device 10^{E} and be included in an apparatus and system, according to any of FIG. 3, 3A or 4. With particular attention to the combined energy recovery device 10^{E} of FIG. 4, the two energy recovery device stages x′, x″ of the energy recovery device 10^{E} each of which separately includes an energy recovery stage are, indicated by a broken line “a” but such is included only for purposes of illustration and not necessarily physically present in the combined energy recovery device 10^{E}. The operation of the combined energy recovery device 10^{E} is readily understood with reference to FIG. 3. In FIG. 4, stage x′ operates as does FIG. 3's ERD 10, and stage x″ operates as does FIG. 3's ERD 10′, as in the combined energy recovery device 10^{E}, the first stage x′ and second stage x″ operate in the same independent manner. In the embodiment of the combined energy recovery device 10^{E}, a difference is present insofar that optionally, and as is shows, the tube 40a″ interconnecting the low pressure fluid outlet 18 of the first stage x′ and the high pressure fluid inlet 16 of the second stage x″ is within the interior of the housing 10h of the combined energy recovery device 10^{E}. In this manner, a more compact combined energy recovery device 10^{E} may be provided, and such may require reduced interconnected tubing between component parts of the apparatus and system.

It is further to be understood that one or more combined energy recovery device 10^{E} may be provided and used in apparatus and systems which concurrently include other types of energy recovery devices, such as depicted as ERDs 10, 10′ and 10ⁿ as disclosed on FIGS. 3, 3A.

It is further to be understood that one or more ERDs, i.e, 10, 10′ and 10ⁿ as disclosed on FIGS. 3, 3A as well as combined ERDs such as 10^{E} of FIG. 4 may be substituted or used conjointly with energy recovery devices (ERDs) which differ from the a unitary pump and turbine energy exchanger, such as is disclosed in U.S. Pat. No. 9,759,066 and discussed herein, particularly with reference to FIGS. 1 and 2.

In preferred apparatus and systems, also within the scope of the present invention, the present inventor has surprisingly found that, as is exemplified herein, using a “waste” stream pressure (at a lower flowrate relative to the total influent stream, namely) to drive two symmetric ERD devices, it was possible to boost the overall influent pressure by >20%. With the pump circuits (z1) in parallel and the turbine circuits (z2) in series, it was determined that each ERD consumed a proportional amount, of approximately 50% of the waste stream pressure. This provided a process is so effective that even different ERDs and/or further numbers of the same types of ERDs when added to the system and apparatus, effectively operated in tandem, cooperatively boosting to a common output pressure from their first internal circuits (al) while their individuals rotors spin at different speeds to accommodate the individual ERD's unit performance.

### EXAMPLE 1

An apparatus and system for a separation process, here comprising two identical ERDs consistent with the schematic depiction of FIG. 3 was constructed, and operated to and evaluated. The performance characteristics of the 1^{st} ERD (labeled “10” in FIG. 3) and the 2^{nd} ERD (labeled “10′” in FIG. 3) in an aqueous purification process are reported on the following two tables. In each of these two tables:
Speed=rotor RPMs
Turbine Inlet=16
Turbine outlet=18
Pump Inlet=20
Pump Outlet=22

1st ERD (10)

| | Turbine | Turbine | Pump | Pump | | |
|---|---|---|---|---|---|---|
| Speed | Inlet | Outlet | Inlet | Outlet | Boost | Boost |
| (RPM) | (PSI) | (PSI) | (PSI) | (PSI) | (PSI) | (%) |
| 420.52 | 229.29 | 127.39 | 183.98 | 240.73 | 56.75 | 30.65% |

2nd ERD (10′)

| | Turbine | Turbine | Pump | Pump | | |
|---|---|---|---|---|---|---|
| Speed | Inlet | Outlet | Inlet | Outlet | Boost | Boost |
| (RPM) | (PSI) | (PSI) | (PSI) | (PSI) | (PSI) | (%) |
| 528.51 | 127.68 | 4.86 | 182.84 | 238.64 | 55.80 | 30.52% |

From these two tables it can be appreciated that
a) the ERD 10 and ERD 10′ operated at different RPMs, yet the pump inlets and pump outlets provided approximately the same ‘boost’ in pressure;
b) the pressure drop across the turbine-side of ERD 10, and ERD 10′ respectively as 101.9 psi, and 122.82 psi—and notably as there was no pressure regulation device downstream of the last ERD (10′) the turbine outlet pressure dropped to nearly zero psi, thus indicating that the energies of the stream entering ERD 10 at its turbine inlet, and exiting the last (second) ERD 10′ in the apparatus was substantially transferred to the pump-side circuits (z1) of the ERDs,
c) the transfer of energy from the second circuits z1 of ERD 10, and ERD 10′ to corresponding first circuits of each, manifested respectively in a boost of 56.75 psi and 55.80 psi.

That nearly equivalent operating efficiencies of ERD 10 and ERD 10′ occurred, particularly wherein there existed a disparity in the pressures between the two internal fluid circuits (z1, z2), respectively the pump-side and the turbine-sides of the individual ERDs, passing through each ERD during steady state operation, while at the same time maintaining effective operation (i.e, avoiding ‘rotor lock up’) of the ERDs was unexpected.

### EXAMPLE 2

An apparatus and system for a separation process, using the same apparatus as in Example 1 was undertaken at different operating parameters, again in an aqueous purification process. The results are reported on the following two tables.

1st ERD (10)

| | Turbine | Turbine | Pump | Pump | | |
|---|---|---|---|---|---|---|
| Speed | Inlet | Outlet | Inlet | Outlet | Boost | Boost |
| (RPM) | (PSI) | (PSI) | (PSI) | (PSI) | (PSI) | (%) |
| 359.41 | 251.81 | 137.06 | 190.68 | 253.67 | 63.00 | 33.04% |

2nd ERD (10′)

| | Turbine | Turbine | Pump | Pump | | |
|---|---|---|---|---|---|---|
| Speed | Inlet | Outlet | Inlet | Outlet | Boost | Boost |
| (RPM) | (PSI) | (PSI) | (PSI) | (PSI) | (PSI) | (%) |
| 451.31 | 134.63 | 3.94 | 191.49 | 255.73 | 64.25 | 33.55% |

From these two tables it can be appreciated that
a) the ERD 10 and ERD 10′ operated at different RPMs, yet the pump inlets and pump outlets provided approximately the same ‘boost’ in pressure;
b) the pressure drop across the turbine inlet and turbine outlet of ERD 10, and ERD 10′ respectively as 114.8 psi, and 130.5 psi—and notably as there was no pressure regulation device downstream of the last ERD (10′) the turbine outlet pressure dropped to nearly zero psi, thus indicating that the energies of the stream entering ERD 10 at its turbine inlet, and exiting the last (second) ERD 10′ in the apparatus was substantially transferred to the pump-side circuits (z1) of the ERDs,
c) the transfer of energy from the second circuits z1 of ERD 10, and ERD 10′ to corresponding first circuits of each, manifested respectively in a boost of 63 psi and 64.25 psi.

That nearly equivalent operating efficiencies of ERD 10 and ERD 10′ occurred, particularly wherein there existed a disparity in the pressures between the two internal fluid circuits (z1, z2), respectively the pump-side and the turbine-sides of the individual ERDs, passing through each ERD during steady state operation, while at the same time maintaining effective operation (i.e, avoiding ‘rotor lock up’) of the ERDs was unexpected.

### EXAMPLE 3

An apparatus and system for a separation process, using the same apparatus as in Example 1 was undertaken at different operating parameters, again in an aqueous purification process. The results are reported on the following two tables.

1st ERD (10)

| | Turbine | Turbine | Pump | Pump | | |
|---|---|---|---|---|---|---|
| Speed | Inlet | Outlet | Inlet | Outlet | Boost | Boost |
| (RPM) | (PSI) | (PSI) | (PSI) | (PSI) | (PSI) | (%) |
| 441.37 | 223.09 | 119.83 | 180.28 | 227.63 | 47.34 | 26.26% |

2nd ERD (10′)

| | Turbine | Turbine | Pump | Pump | | |
|---|---|---|---|---|---|---|
| Speed | Inlet | Outlet | Inlet | Outlet | Boost | Boost |
| (RPM) | (PSI) | (PSI) | (PSI) | (PSI) | (PSI) | (%) |
| 543.41 | 119.41 | 4.99 | 178.12 | 225.15 | 47.03 | 26.40% |

From these two tables it can be appreciated that
a) the ERD 10 and ERD 10′ operated at different RPMs, yet the pump inlets and pump outlets provided approximately the same ‘boost’ in pressure;
b) the pressure drop across the turbine inlet and turbine outlet of ERD 10, and ERD 10′ respectively as 103.2 psi, and 114.4 psi—and notably as there was no pressure regulation device downstream of the last ERD (10′) the turbine outlet pressure dropped to nearly zero psi, thus indicating that the energies of the stream entering ERD 10 at its turbine inlet, and exiting the last (second) ERD 10′ in the apparatus was substantially transferred to the pump-side circuits (z1) of the ERDs,
c) the transfer of energy from the second circuits z1 of ERD 10, and ERD 10′ to corresponding first circuits of each, manifested respectively in a boost of 47.34 psi and 47.03 psi.

That nearly equivalent operating efficiencies of ERD 10 and ERD 10′ occurred, particularly wherein there existed a disparity in the pressures between the two internal fluid circuits (z1, z2), respectively the pump-side and the turbine-sides of the individual ERDs, passing through each ERD during steady state operation, while at the same time maintaining effective operation (i.e, avoiding ‘rotor lock up’) of the ERDs was unexpected.

### EXAMPLE 4

An apparatus and system for a separation process, using the same apparatus as in Example 1 was undertaken at different operating parameters, again in an aqueous purification process. The results are reported on the following two tables.

1st ERD (10)

| | Turbine | Turbine | Pump | Pump | | |
|---|---|---|---|---|---|---|
| Speed | Inlet | Outlet | Inlet | Outlet | Boost | Boost |
| (RPM) | (PSI) | (PSI) | (PSI) | (PSI) | (PSI) | (%) |
| 493.41 | 195.43 | 107.15 | 167.02 | 200.43 | 33.41 | 20.00% |

2nd ERD (10′)

| | Turbine | Turbine | Pump | Pump | | |
|---|---|---|---|---|---|---|
| Speed | Inlet | Outlet | Inlet | Outlet | Boost | Boost |
| (RPM) | (PSI) | (PSI) | (PSI) | (PSI) | (PSI) | (%) |
| 588.56 | 103.28 | 5.51 | 167.43 | 200.01 | 32.58 | 19.46% |

From these two tables it can be appreciated that
a) the ERD 10 and ERD 10′ operated at different RPMs, yet the pump inlets and pump outlets provided approximately the same ‘boost’ in pressure;
b) the pressure drop across the turbine inlet and turbine outlet of ERD 10, and ERD 10′ respectively as 88.5 psi, and 97.8 psi—and notably as there was no pressure regulation device downstream of the last ERD (10′) the turbine outlet pressure dropped to nearly zero psi, thus indicating that the energies of the stream entering ERD 10 at its turbine inlet, and exiting the last (second) ERD 10′ in the apparatus was substantially transferred to the pump-side circuits (z1) of the ERDs,
c) the transfer of energy from the second circuits z1 of ERD 10, and ERD 10′ to corresponding first circuits of each, manifested respectively in a boost of 33.4 psi and 32.6 psi.

That nearly equivalent operating efficiencies of ERD 10 and ERD 10′ occurred, particularly wherein there existed a disparity in the pressures between the two internal fluid circuits (z1, z2), respectively the pump-side and the turbine-sides of the individual ERDs, passing through each ERD during steady state operation, while at the same time maintaining effective operation (i.e, avoiding ‘rotor lock up’) of the ERDs was unexpected.

I claim:

1. A system or apparatus comprising two or more energy recovery devices, and/or at least one (or two or more) energy recovery device having two or more energy recovery device stages, wherein:
each of energy recovery devices having a first internal fluid circuit having an inlet and an outlet, a second internal fluid circuit having an inlet and an outlet, a rotor or turbine which, operates in response to differential pressures between the inlet and outlet of the first internal circuit, and/or operates in response to differential pressures between the inlet and outlet of the second internal fluid circuit, such that during operation a pressure increase in a fluid in the first internal fluid circuit occurs while a pressure decrease in a fluid in the second internal fluid circuit occurs due to energy transfer between the first internal fluid circuit and the second internal fluid circuit;
the inlets of each of the first internal fluid circuits connected and in fluid communication with a first common conduit, pipe, tube or manifold, and
the outlets of each of the first internal fluid circuits connected to and in fluid communication with a second separate common conduit, pipe, tube or manifold, thereby forming a parallel circuit of the first internal fluid circuits of the energy recovery devices;
the outlet of the second internal fluid circuit of an upstream energy recovery device in fluid communication to the inlet of the second internal fluid circuit of downstream energy recovery device, and thereby forming a series circuit between said energy recovery devices;
a pump, in fluid communication with the first common conduit, pipe, tube or manifold via which is supplied a pressurized fluid to the energy recovery devices,
a separator unit, having an input fluid communication with the second separate common conduit, pipe, tube or manifold, further having at least two outlets, one of the outlets being in fluid communication with the series circuit between second internal fluid circuits of the energy recovery devices.

2. The system or apparatus of claim 1, comprising more than two energy recovery devices, on an energy recovery device having at least three energy recovery device stages.

3. The system or apparatus of claim 1, wherein the energy recovery devices are of the same configuration.

4. The system or apparatus of claim 1, wherein at least two of the energy recovery devices are of different configuration.

5. The system or apparatus of claim 1, wherein the separator unit is an osmotic separator.

6. A method of treatment of separation of a fluid, the method comprising the steps of:
treating the fluid in the system or apparatus of claim 1.

7. The method of claim 6, wherein the fluid is water and the separation unit comprises a reverse osmosis membrane.
